(19) United States
(12) Patent Application Publication
(10) Pub. No.: US 2017/0123943 A1
(43) Pub. Date: May 4, 2017

(54) DISTRIBUTED DATA STORAGE AND PROCESSING TECHNIQUES

(71) Applicant: NETAPP, INC., Sunnyvale, CA (US)

(72) Inventors: KARTHIKEYAN NAGALINGAM, Raleigh, NC (US); GUS HORN, Raleigh, NC (US)

(73) Assignee: NETAPP, INC., Sunnyvale, CA (US)

(21) Appl. No.: 14/928,495

(22) Filed: Oct. 30, 2015

(51) Int. Cl. G06F 11/20; H04L 29/08

(52) U.S. Cl. CPC G06F 11/2033; H04L 67/1097; G06F 11/2069; G06F 2201/805; G06F 2201/815

(57) ABSTRACT

Techniques for distributed data storage and processing are described. In one embodiment, for example, a method may be performed that comprises presenting, by processing circuitry of a storage server communicatively coupled with a computing cluster, a first virtual data node to a distributed data storage and processing platform, performing a reliability evaluation procedure to determine whether the first virtual data node constitutes an unreliable virtual data node, and in response to a determination that the first virtual data node constitutes an unreliable virtual data node, performing a virtual data node replacement procedure to replace the first virtual data node with a second virtual data node. The embodiments are not limited in this context.

### BACKGROUND

In a distributed data storage and processing (DDSP) system, the storage and processing demands associated with management of one or more datasets may be collectively accommodated by respective pools of interconnected storage and processing resources. In many DDSP systems, such storage and processing resource pools may comprise respective storage and/or processing resources of each a plurality of interconnected computing devices of a computing cluster. A DDSP platform may generally manage the operations associated with storage and processing of any given dataset. In a typical DDSP system, such operations may include operations associated with data segmentation, replication, distribution, and storage.

### BRIEF DESCRIPTION OF THE DRAWINGS

FIG. 1 illustrates an embodiment of a first computing cluster.

FIG. 2 illustrates an embodiment of a second computing cluster.

FIG. 3 illustrates an embodiment of a third computing cluster.

FIG. 4 illustrates an embodiment of a fourth computing cluster.

FIG. 5 illustrates an embodiment of a first operating environment.

FIG. 6 illustrates an embodiment of a second operating environment.

FIG. 7 illustrates an embodiment of a first logic flow.

FIG. 8 illustrates an embodiment of a second logic flow.

FIG. 9 illustrates an embodiment of a storage medium.

FIG. 10 illustrates an embodiment of a computing architecture.

FIG. 11 illustrates an embodiment of a communications architecture.

### DETAILED DESCRIPTION

Various embodiments are generally directed to techniques for distributed data storage and processing. In one embodiment, for example, a method may be performed that comprises presenting, by processing circuitry of a storage server communicatively coupled with a computing cluster, a first virtual data node to a distributed data storage and processing platform, performing a reliability evaluation procedure to determine whether the first virtual data node constitutes an unreliable virtual data node, and in response to a determination that the first virtual data node constitutes an unreliable virtual data node, performing a virtual data node replacement procedure to replace the first virtual data node with a second virtual data node. The embodiments are not limited in this context.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Distributed data storage and processing (DDSP) is a technique well-suited for use in conjunction with the storage and processing of large datasets. In a DDSP system, respective compute resources and storage resources of each of a plurality of interconnected computing devices (such as servers) in a computing cluster may be collectively used to store and process data. The compute resources available via the various computing devices in the DDSP system may generally comprise hardware featuring processing capabilities. For example, each compute resource in a particular DDSP system may comprise/correspond to a respective processor or processor core. The storage resources available via the various computing devices in the DDSP system may generally comprise hardware featuring storage capabilities. For example, each storage resource in a particular DDSP system may comprise/correspond to a respective hard disk or set of hard disks. The embodiments are not limited to these examples.

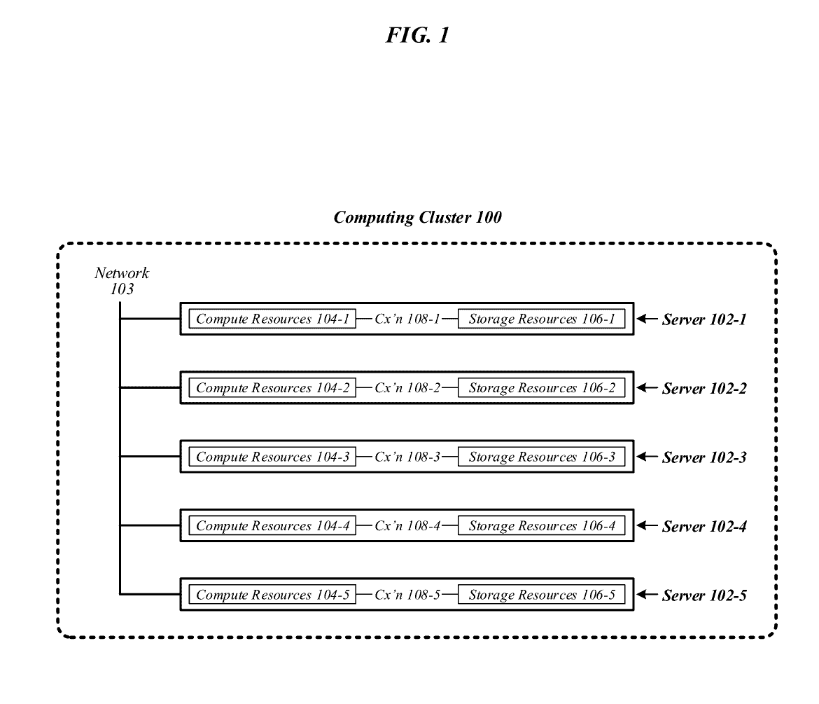

FIG. 1 illustrates a simple example of a computing cluster 100 that may be representative of a computing cluster that may be used to implement a DDSP system according to various embodiments. In the example of FIG. 1, computing cluster 100 comprises servers 102-1 to 102-5. Servers 102-1 to 102-5 comprise respective compute resources 104-1 to 104-5 and storage resources 106-1 to 106-5, which are configured to communicate with each other via respective connections 108-1 to 108-5. Servers 102-1 to 102-5 are connected to each other via a network 103. In some embodiments, network 103 may comprise a local area network (LAN), such as an Ethernet network. The embodiments are not limited in this context.

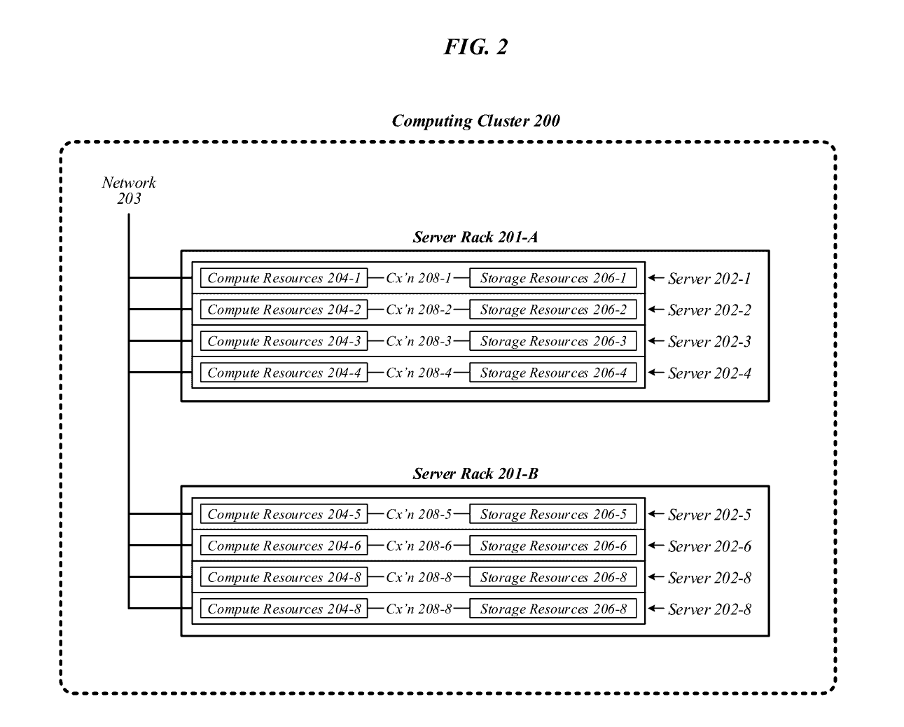

FIG. 2 illustrates a computing cluster 200 that may be representative of another example of a computing cluster that may be used to implement a DDSP system according to various embodiments. More particularly, computing cluster 200 may be representative of an example of an implementation of such a computing cluster using rack servers. In computing cluster 200, servers 202-1 to 202-8 are distributed among server racks 201-A and 201-B. More particularly, server rack 201-A contains servers 202-1 to 202-4, and server rack 201-B contains servers 202-5 to 202-8. In fashion analogous to the architecture of computing cluster 100 of FIG. 1, the servers 202-1 to 202-8 in computing cluster 200 are connected to each other via a network 203. Servers 202-1 to 202-8 comprise respective compute resources 204-1 to 204-8 and storage resources 206-1 to 206-8, which are configured to communicate with each other via respective connections 208-1 to 208-8. The embodiments are not limited to this example.

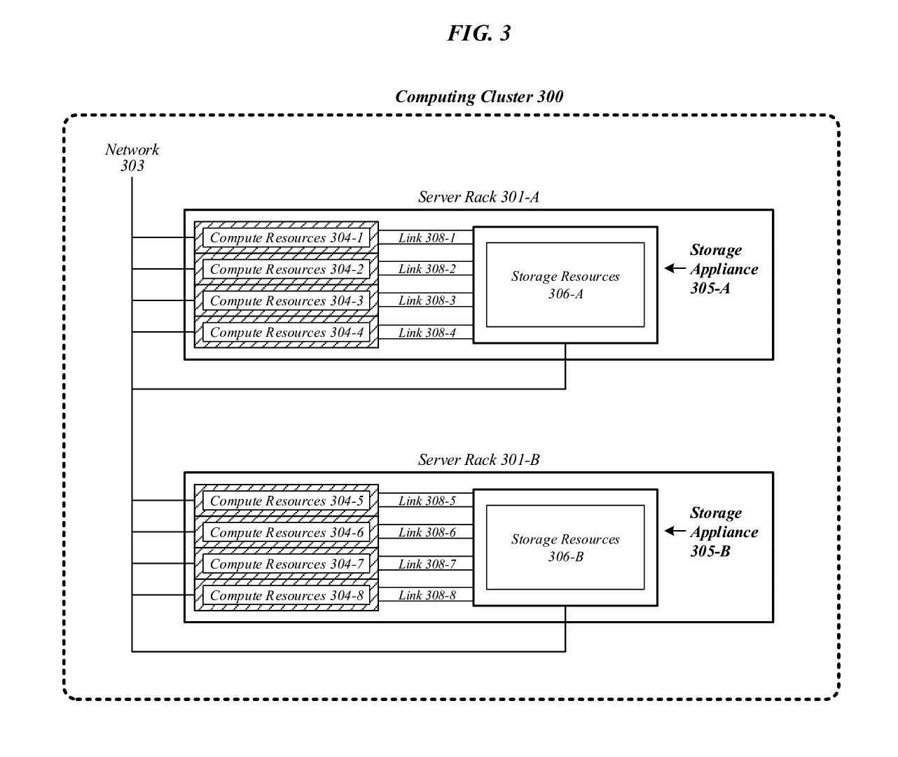

FIG. 3 illustrates a computing cluster 300 that may be representative of a third example of a computing cluster that may be used to implement a DDSP system according to some embodiments. More particularly, computing cluster 300 may be representative of an example of an implementation of such a computing cluster using rack servers and dedicated data storage appliances. In computing cluster 300, servers containing compute resources 304-1 to 304-8 are distributed among server racks 301-A and 301-B, which contain respective storage appliances 305-A and 305-B. More particularly, servers containing compute resources 304-1 to 304-4 reside in server rack 301-A, and servers containing compute resources 304-5 to 304-8 reside in server rack 301-B. In fashion analogous to the architectures of computing clusters 100 and 200 of FIGS. 1 and 2, the servers in computing cluster 300—which are illustrated using cross-hatching—are connected via a network 303. In this example, storage appliances 305-A and 305-B are also connected to network 303. In various embodiments, storage appliances 305-A and 305-B may contain respective data storage arrays comprised of multiple storage devices, such as hard disk drives or solid-state drives. In server rack 301-A, the servers containing compute resources 304-1 to 304-4 are communicatively coupled to storage resources 306-A of storage appliance 305-A via links 308-1 to 308-4. Likewise, in server rack 301-B, the servers containing compute resources 304-5 to 304-8 are communicatively coupled to storage resources 306-B of storage appliance 305-B via links 308-5 to 308-8. The embodiments are not limited to this example.

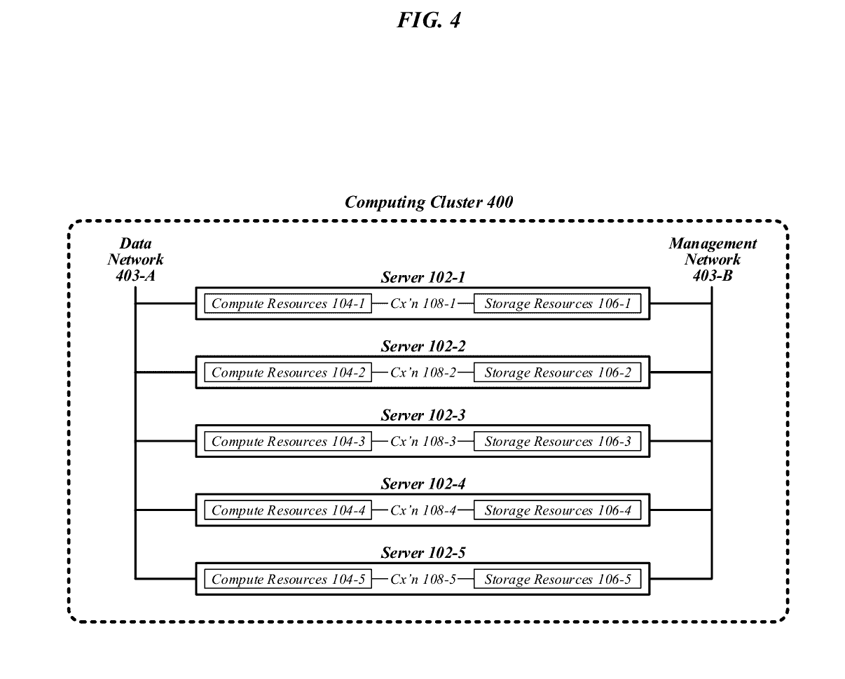

It is worthy of note that in some embodiments, the devices within a given computing cluster may be interconnected via more than one network. FIG. 4 illustrates a computing cluster 400 that may be representative of an example of such a computing cluster. Computing cluster 400 features the same servers 102-1 to 102-5 as are featured in computing cluster 100 of FIG. 1. However, in computing cluster 400, these servers are interconnected via both a data network 403-A and a management network 403-B. In various embodiments, data network 403-A may generally comprise a network designed to enable high-speed data communications with/among the various servers in computing cluster 400. In some embodiments, management network 403-B may generally comprise a network designed to enable communications with/among the various servers in computing cluster 400 such as may be associated with the performance of various system administration operations. In various embodiments, management network 403-B may comprise a lower-speed network relative to data network 403-A. For example, in some embodiments, data network 403-A may comprise a 10 Gigabit Ethernet (10 GbE) network, and management network 403-B may comprise a 1 Gigabit Ethernet (1 GbE) network. It is to be appreciated that such a multi-network arrangement may be implemented in conjunction with any of computing clusters 100, 200, and 300 of FIGS. 1-3. For example, in various embodiments, the various servers and storage appliances in computing cluster 300 of FIG. 3 may be interconnected via both a data network and a management network. The embodiments are not limited to this example.

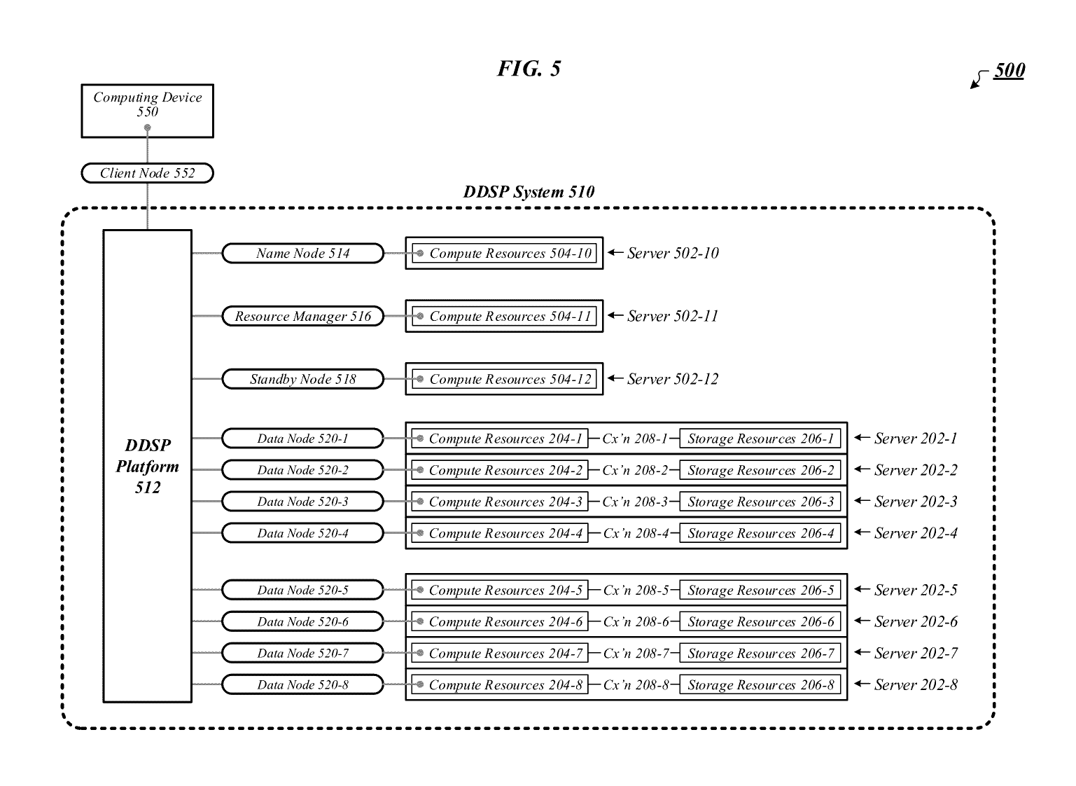

FIG. 5 illustrates an example of an operating environment 500 that may be representative of some/var embodiments. In operating environment 500, the operations associated with the storage and processing of a dataset in a DDSP system 510 may generally be managed by a DDSP platform 512. DDSP platform 512 may generally comprise any combination of hardware and/or software configurable to manage storage and processing operations in DDSP system 510 in such a way as to support distributed storage and processing of one or more datasets within DDSP system 510. In some embodiments, DDSP platform 512 may comprise a Hadoop software framework, such as a Hadoop 1.0 framework or a Hadoop 2.0 framework. As shown in FIG. 5, DDSP system 510 may comprise the same servers 202-1 to 202-8 as are comprised in computing cluster 200 of FIG. 2, as well as additional servers 502-10, 502-11, and 502-12. In various embodiments, these servers may be connected to each other via one or more networks, such as one or more Ethernet networks. The embodiments are not limited in this context.

In some embodiments, the collective operations of DDSP platform 512 may consist of respective operations of each of a plurality of logical nodes, each of which may operate according to one of multiple defined roles. In various embodiments, each server in DDSP system 510 may be configured to operate as one of such logical nodes. In some embodiments, configuring a given server to operate as one of such logical nodes may involve configuring that server with software comprising code that, when executed by one or more compute resources of the server, result in the instantiation of one or more software processes corresponding to one of such defined roles. The embodiments are not limited in this context.

In various embodiments, server 502-10 may be configured to operate as a name node 514. In some embodiments, in conjunction with operating as name node 514, server 502-10 may generally be responsible for managing a namespace for a file system of DDSP platform 512. In various such embodiments, the file system may comprise a Hadoop Distributed File System (HDFS). In some embodiments, server 502-11 may be configured to operate as a resource manager 516. In various embodiments, in conjunction with operating as resource manager 516, server 502-11 may generally be responsible for accepting job submissions from applications and allocating resources to applications. In some embodiments, server 502-12 may be configured to operate as a standby node 518. In various embodiments, in conjunction with operating as standby node 518, server 502-12 may provide failover capability, according to which it may assume the role of name node 514 and preserve data availability in the event of a failure of server 502-10. In some embodiments, servers 202-1 to 202-8 may be configured to operate as respective data nodes 520-1 to 520-8. In various embodiments, in conjunction with operating as data nodes 520-1 to 520-8, servers 202-1 to 202-8 may store data blocks that make up the file system of DDSP platform 512, serve input/output (I/O) requests, and/or perform tasks associated with various application-submitted jobs. In some embodiments, DDSP platform 512 may recognize the unique identities of data nodes 520-1 to 520-8 based on unique respective data node identifiers (IDs) that are assigned to data nodes 520-1 to 520-8. The embodiments are not limited in this context.

In various embodiments, a computing device 550 may be configured to operate as a client node 552. In some embodiments, configuring computing device 550 to operate as client node 552 may involve configuring computing device 550 with software comprising code that, when executed by one or more compute resources of computing device 550, result in the instantiation of one or more software processes corresponding to a defined client role of DDSP platform 512. In various embodiments, operation as client node 552 may enable computing device 550 to store data in DDSP system 510 via DDSP platform 512. The embodiments are not limited in this context.

In some embodiments, in conjunction with storing a dataset in DDSP system 510, DDSP platform 512 may segment the dataset into a plurality of data blocks and store the data blocks in a distributed fashion across the various storage resources of DDSP system 510. In various embodiments, each data block that DDSP platform 512 stores may be directed to a respective one of data nodes 520-1 to 520-8. In some embodiments, any given data node may generally have access only to the storage resources that are accessible to the server operating as that data node, and thus the data node may store each data block that it receives using storage comprised among those storage resources. Likewise, the storage resources comprised in any given server may generally be accessible only to the data node as which that server operates. For example, the only storage resources accessible to data node 520-1 may be storage resources 206-1, and the only data node able to access storage resources 206-1 may be data node 520-1. The embodiments are not limited in this context.

In various embodiments, if a storage resource fails, or the server/data node that comprises it fails, any data blocks stored within the storage resource may become inaccessible to the client. As such, in some embodiments, in order to safeguard the integrity and availability of the dataset, DDSP platform 512 may store multiple copies of each data block. In various embodiments, the number of copies that DDSP platform 512 stores may be determined by a configured value of a data replication factor of the DDSP platform 512. In some embodiments, with respect to each data block, DDSP platform 512 may store a number of copies equal to the value of the data replication factor. For example, DDSP platform 512 may store three copies of each data block when the data replication factor is set to a value of 3. In various embodiments, DDSP platform 512 may be configured to actively monitor the number of accessible copies of each data block, and to take corrective action when it detects that there are not enough accessible copies of any given data block. For example, in some embodiments, if a data node fails, DDSP platform 512 may detect that there are no longer enough accessible copies of any data blocks that have been stored at that data node, and may initiate a re-replication process to store new copies of those data blocks at other data nodes.

In various embodiments, ensuring such redundancy may reduce the chances that hardware failures will render portions of the dataset inaccessible to the client. However, the re-replication process may impose a significant burden in the form of processing, memory, and communication overhead, and may have the potential to negatively impact the performance of DDSP system 510. Furthermore, greater quantities of storage resources and compute resources may be required to support this approach. As dataset size increases, these requirements may become prohibitive, and may lead to rapid data center sprawl. In view of these considerations, in order to accommodate the data storage requirements that may be associated with large datasets, it may be desirable to implement enhanced distributed data storage and processing techniques according to which the need for data replication is reduced or eliminated. In order to support the seamless implementation of such techniques in existing systems and preserve compatibility with DDSP platforms in such systems, it may be desirable that such enhanced distributed data storage and processing techniques be designed to be agnostic to those DDSP platforms.

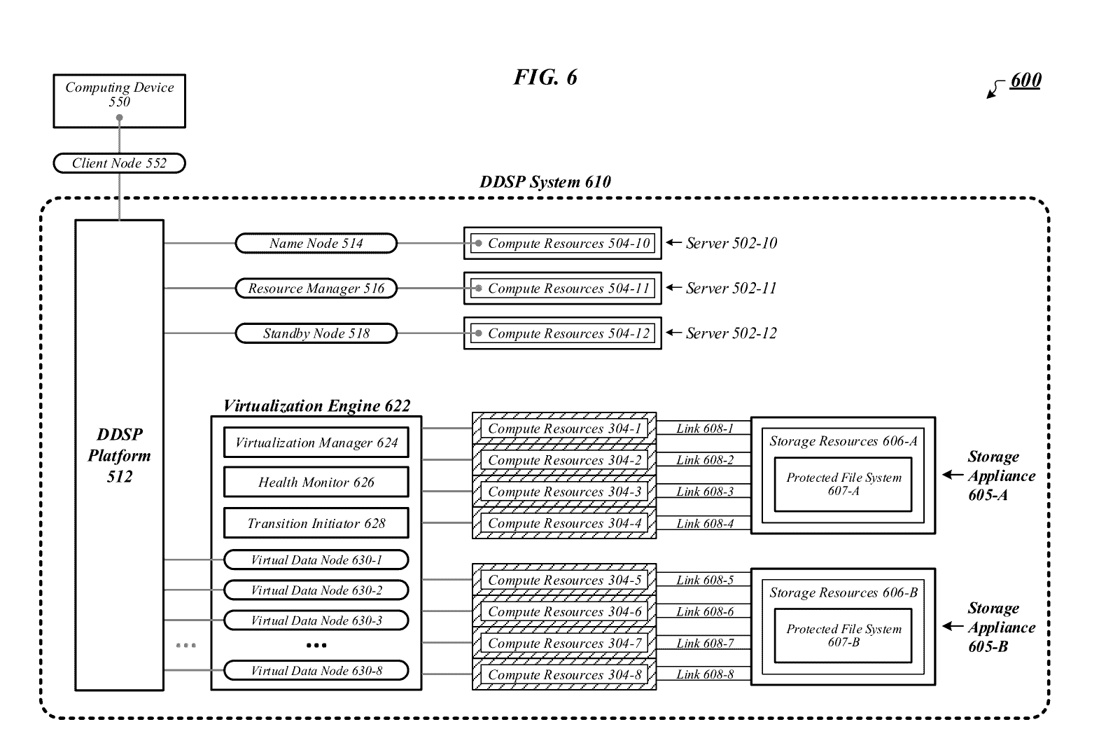

FIG. 6 illustrates an example of an operating environment 600 that may be representative of the implementation of one or more enhanced distributed data storage and processing techniques according to some embodiments. In operating environment 600, a DDSP system 610 is implemented using the same servers that are comprised in computing cluster 300 of FIG. 3, as well as the servers 502-10, 502-11, and 502-12 of FIG. 5. Also comprised in DDSP system 610 are storage appliances 605-A and 605-B. In various embodiments, the servers and storage appliances in DDSP system 610 may be connected to each other via one or more networks. For example, in some embodiments, the servers and storage appliances in DDSP system 610 may be connected to each other via a data network that is the same as, or similar to, data network 403-A of FIG. 4 and a management network that is the same as, or similar to, management network 403-B of FIG. 4. The embodiments are not limited in this context.

In various embodiments, storage appliances 605-A and 605-B may comprise respective storage resources 606-A and 606-B. In some embodiments, storage resources 606-A and 606-B may comprise storage of a type enabling storage appliances 605-A and 605-B to implement protected file systems 607-A and 607-B. For example, in various embodiments, storage resources 606-A and 606-B may comprise redundant array of independent disks (RAID) 5 storage arrays, RAID 6 storage arrays, or dynamic disk pools (DDPs). In some embodiments, implementing protected file systems 607-A and 607-B may enable storage appliances 605-A and 605-B to provide data storage with high reliability, such as 99.999% reliability. In various embodiments, the servers containing compute resources 304-1 to 304-4 may be communicatively coupled to the storage resources 606-A of storage appliance 605-A via respective links 608-1 to 608-4, and the servers containing compute resources 304-5 to 304-8 may be communicatively coupled to the storage resources 606-B of storage appliance 605-B via respective links 608-5 to 608-8. In some embodiments, one or more of links 608-1 to 608-8 may comprise internet small computer system interface (iSCSI) links. In various embodiments, one or more of links 608-1 to 608-8 may comprise Fibre Channel (FC) links. In some embodiments, one or more of links 608-1 to 608-8 may comprise InfiniBand links. The embodiments are not limited in this context.

In various embodiments, using protected file systems 607-A and 607-B, storage appliances 605-A and 605-B may provide storage with reliability at a level high enough to render data replication unnecessary within DDSP system 610. In some such embodiments, DDSP platform 512 may thus be configured to refrain from data replication. In various embodiments, a data replication factor for DDSP platform 512 may be set to a value of 1 in order to configure DDSP platform 512 to refrain from data replication. In some other embodiments, rather than being configured to forgo data replication entirely, DDSP platform 512 may be configured to replicate each data block a lesser number of times. For example, in various embodiments, the data replication factor for DDSP platform 512 may be reduced from 3 to 2. In some embodiments, configuring DDSP platform 512 to refrain from replication or configuring DDSP platform 512 with a lower data replication factor may result in a corresponding reduction in the amounts of storage and compute resources that are consumed in conjunction with storage of any given portion of client data. The embodiments are not limited in this context.

In various embodiments, DDSP system 610 may implement a virtualization engine 622. Virtualization engine 622 may generally comprise any combination of hardware and/or software configurable to implement a data node virtualization scheme for DDSP system 610. In some embodiments, according to the data node virtualization scheme, servers may no longer be configured to operate as data nodes of DDSP platform 512. Instead, compute resources of such servers may be used to instantiate virtual computing entities, such as virtual machines, and those virtual computing entities may be configured to operate as data nodes of DDSP platform 512. In the example of FIG. 6, virtualization engine 622 may implement a data node virtualization scheme according to which virtual data nodes 630-1 to 630-8 are instantiated using compute resources comprised among the compute resources 304-1 to 304-8 of the servers in computing cluster 300 of FIG. 3. In various embodiments, according to the data node virtualization scheme, virtual data nodes 630-1 to 630-8 may be indistinguishable from traditional data nodes—such as data nodes 520-1 to 520-8 of FIG. 5—from the perspective of DDSP platform 512. The embodiments are not limited in this context.

In some embodiments, virtualization engine 622 may comprise a virtualization manager 624. In various embodiments, virtualization manager 624 may generally be operative to oversee data node virtualization operations in DDSP system 610, and for ensuring that each virtual data node being presented to DDSP platform 512 is functioning properly. In some embodiments, virtualization engine 622 may comprise a health monitor 626. In various embodiments, health monitor 626 may generally be operative to determine and/or track respective health metrics for each virtual data node being presented to DDSP platform 512. In some embodiments, health monitor 626 may comprise and/or correspond to a distinct respective health monitoring process of each virtual data node. In various embodiments, virtualization engine 622 may comprise a transition initiator 628. In some embodiments, transition initiator 628 may generally be responsible for replacing existing virtual data nodes with new virtual data nodes such as may become necessary and/or desirable during operation of DDSP system 610. The embodiments are not limited in this context.

In various embodiments, virtualization engine 622 may instantiate virtual data nodes 630-1 to 630-8 using compute resources comprised among compute resources 304-1 to 304-8 and may present virtual data nodes 630-1 to 630-8 to DDSP platform 512. In some embodiments, during ongoing operations in DDSP system 610 subsequent to the instantiation and presentation of virtual data nodes 630-1 to 630-8, virtualization manager 624 may be operative to use a reliability evaluation procedure to determine whether any of virtual data nodes 630-1 to 630-8 has become unreliable. In various embodiments, virtualization manager 624 may perform the reliability evaluation procedure periodically for each virtual data node.

In some embodiments, according to the reliability evaluation procedure, virtualization manager 624 may query health monitor 626 for a health score for a given virtual data node. In various embodiments, health monitor 626 may respond to the query by notifying virtualization manager 624 of a health score for the virtual data node. In some embodiments, health monitor 626 may determine the health score for the virtual data node based on one or more health metrics that it may track for the virtual data node. The embodiments are not limited in this context.

In various embodiments, virtualization manager 624 may compare the health score to a health score threshold. In some embodiments, the health score threshold may comprise a statically defined/configured value. In various other embodiments, virtualization manager 624 may dynamically adjust the health score threshold during ongoing operation of DDSP system 610. In some such embodiments, virtualization manager 624 may dynamically adjust the health score threshold based on observed conditions within DDSP system 610. In various embodiments, virtualization manager 624 may implement one or more machine learning techniques in conjunction with such dynamic health score threshold adjustment. The embodiments are not limited in this context.

In some embodiments, if the health score for the virtual data node is greater than the health score threshold, virtualization manager 624 may conclude that the virtual data node is sufficiently reliable. In various embodiments, if the health score for the virtual data node is less than the health score threshold, virtualization manager 624 may conclude that the virtual data node is unreliable. In some embodiments, virtualization manager 624 may also conclude that the virtual data node is unreliable if health monitor 626 does not respond to the query submitted by virtualization manager 624. The embodiments are not limited in this context.

In various embodiments, if virtualization manager 624 determines that a given virtual data node is unreliable, transition initiator 628 may perform a virtual data node replacement procedure to replace that unreliable virtual data node with a new virtual data node. In some embodiments, the virtual data node replacement procedure may involve instantiating the new virtual data node using compute resources comprised among those of a spare compute resource pool of the computing cluster in DDSP system 610. In various embodiments, according to the virtual data node replacement procedure, the new virtual data node may appear, from the perspective of DDSP platform 512, to be the same data node as did the unreliable virtual data node.

In some embodiments, by performing the virtual data node replacement procedure, transition initiator 628 may replace the unreliable virtual data node in rapid fashion, such that DDSP platform 512 does not perceive any data node failure. As a result, DDSP platform 512 may not initiate the re-replication process discussed above with respect to operating environment 500 of FIG. 5, and the various burdens associated with that process may thus be avoided. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

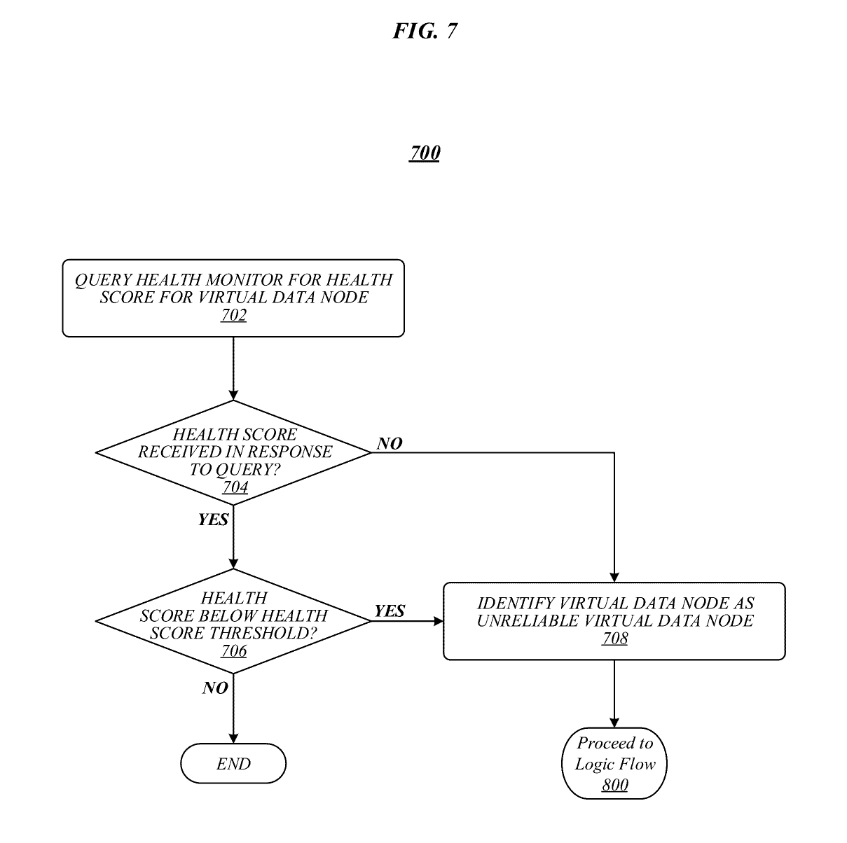

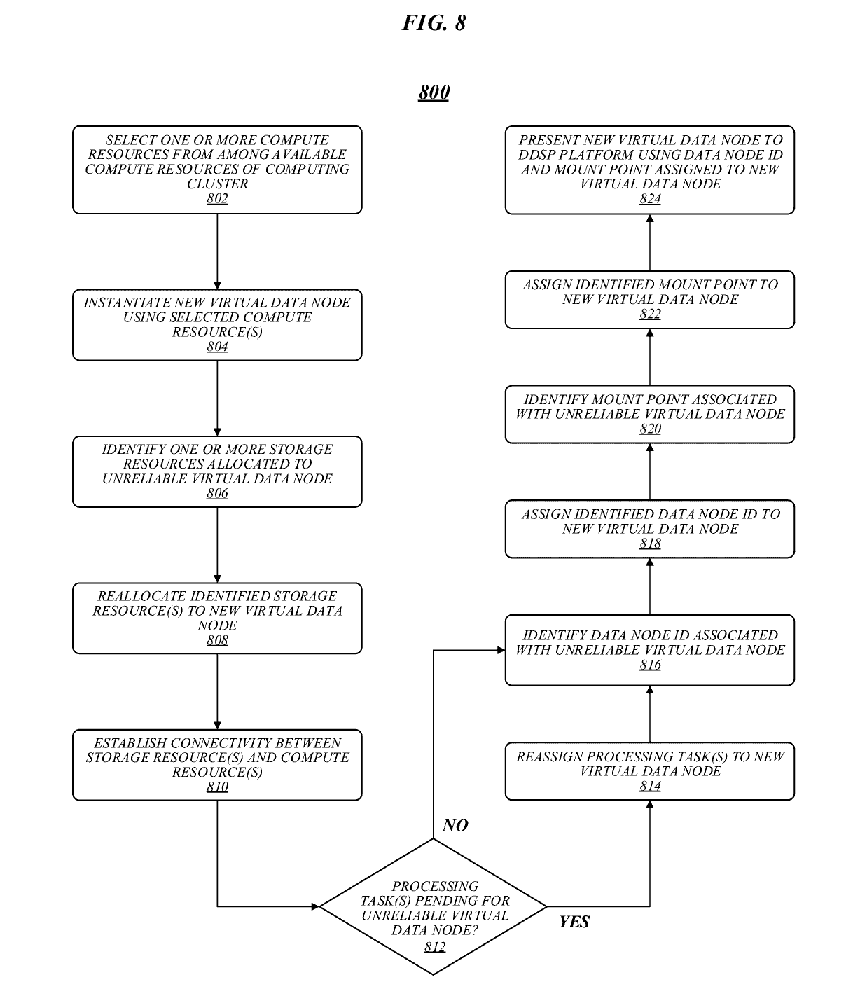

FIG. 7 illustrates an embodiment of a logic flow 700 that may be representative of a reliability evaluation procedure that may be performed in various embodiments by virtualization manager 624 of FIG. 6. As shown in FIG. 7, a health monitor may be queried for a health score for a virtual data node at 702. For example, virtualization manager 624 of FIG. 6 may query health monitor 626 for a health score for virtual data node 630-1. At 704, it may be determined whether a response to the query has been received. If a health score for the virtual data node has been received, flow may pass to 706, where the received health score may be compared to a health score threshold. If the health score is below the health score threshold, the virtual data node may be identified as an unreliable virtual data node at 708. The virtual data node also may be identified as an unreliable virtual data node at 708 if it is determined at 704 that no response to the query at 702 has been received. For example, if a health score that virtualization manager 624 of FIG. 6 receives for virtual data node 630-1 is below the health score threshold, or if health monitor 626 does not respond to the query from virtualization manager 624, virtualization manager 624 may identify virtual data node 630-1 as an unreliable virtual data node. From 708, flow may proceed to logic flow 800 of FIG. 8.

The logic flow 800 illustrated in FIG. 8 may be representative of an example of a virtual data node replacement procedure that may be performed in some/var embodiments by transition initiator 628 of FIG. 6. As shown in FIG. 8, according to logic flow 800, one or more compute resources may be selected at 802, from among available compute resources of a computing cluster. For example, transition initiator 628 of FIG. 6 may select one or more compute resources from among available compute resources comprised among compute resources 304-1 to 304-8 in DDSP system 610. In some embodiments, the one or more compute resources may be selected from among available compute resources comprised in a spare compute resource pool of the computing cluster. At 804, a new virtual data node may be instantiated using the one or more selected compute resources. For example, transition initiator 628 of FIG. 6 may instantiate a new virtual data node using one or more compute resources selected at 802.

At 806, one or more storage resources allocated to an unreliable virtual data node may be identified. For example, following a determination by virtualization manager 624 of FIG. 6 that virtual data node 630-1 is unreliable, transition initiator 628 may identify one or more storage resources allocated to virtual data node 630. At 808, the one or more identified storage resources may be reallocated to the new virtual data node. For example, transition initiator 628 of FIG. 6 may reallocate one or more storage resources identified at 806 to a new virtual data node instantiated at 804. At 810, connectivity may be established between the one or more storage resources and the one or more compute resources. For example, transition initiator 628 of FIG. 6 may establish connectivity between one or more storage resources reallocated to a virtual data node at 808 and one or more compute resources used to instantiate the new virtual data node at 804. In various embodiments, establishing connectivity between the one or more storage resources and the one or more compute resources may involve one or more network switching operations. The embodiments are not limited in this context.

At 812, it may be determined whether any processing tasks are pending for the unreliable virtual data node. For example, following a determination by virtualization manager 624 of FIG. 6 that virtual data node 630-1 is unreliable, transition initiator 628 may determine whether there are any processing tasks pending for virtual data node 630-1. If it is determined at 812 that one or more processing tasks are pending for the unreliable virtual data node, flow may pass to 814. At 814, the one or more pending processing tasks may be reassigned to the new virtual data node. For example, transition initiator 628 of FIG. 6 may reassign one or more pending processing tasks to a new virtual data node instantiated at 804. From 814, flow may proceed to 816. If it is determined at 812 that no processing tasks are pending for the unreliable virtual data node, flow may pass directly from 812 to 816.

At 816, a data node ID associated with the unreliable virtual data node may be identified. For example, following a determination by virtualization manager 624 of FIG. 6 that virtual data node 630-1 is unreliable, transition initiator 628 may identify a data node ID associated with virtual data node 630-1. At 818, the identified data node ID may be assigned to the new virtual data node. For example, transition initiator 628 of FIG. 6 may assign a data node ID identified at 816 to a new virtual data node instantiated at 804. At 820, a mount point associated with the unreliable virtual data node may be identified. For example, following a determination by virtualization manager 624 of FIG. 6 that virtual data node 630-1 is unreliable, transition initiator 628 may identify a mount point associated with virtual data node 630-1. At 822, the identified mount point may be assigned to the new virtual data node. For example, transition initiator 628 of FIG. 6 may assign a mount point identified at 820 to a new virtual data node instantiated at 804. At 824, the new virtual data node may be presented to a distributed data storage and processing platform using the data node ID and mount point assigned to the virtual data node. For example, virtualization engine 622 of FIG. 6 may present a new virtual data node instantiated at 804 to DDSP platform 512 using a data node ID assigned to the new virtual data node at 818 and a mount point assigned to the new virtual data node at 822. The embodiments are not limited to these examples.

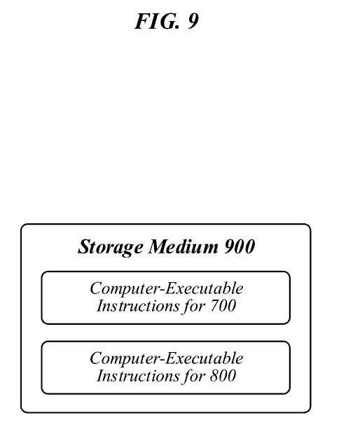

FIG. 9 illustrates an embodiment of a storage medium 900. Storage medium 900 may comprise any non-transitory computer-readable storage medium or machine-readable storage medium, such as an optical, magnetic or semiconductor storage medium. In various embodiments, storage medium 900 may comprise an article of manufacture. In some embodiments, storage medium 900 may store computer-executable instructions, such as computer-executable instructions to implement one or both of logic flow 700 of FIG. 7 and logic flow 800 of FIG. 8. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

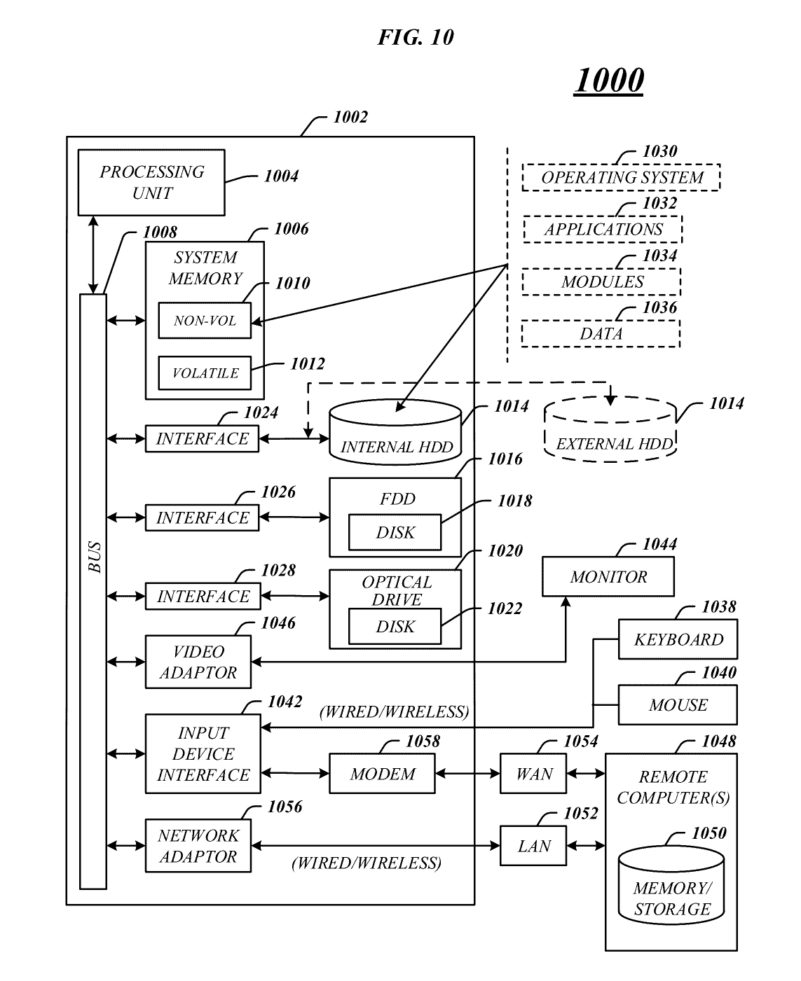

FIG. 10 illustrates an embodiment of an exemplary computing architecture 1000 that may be suitable for implementing various embodiments as previously described. In various embodiments, the computing architecture 1000 may comprise or be implemented as part of an electronic device. In some embodiments, the computing architecture 1000 may be representative, for example, of a server that implements one or more of virtualization engine 622 of FIG. 6, logic flow 700 of FIG. 7, logic flow 800 of FIG. 8, and storage medium 900 of FIG. 9. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the apparatus 600.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

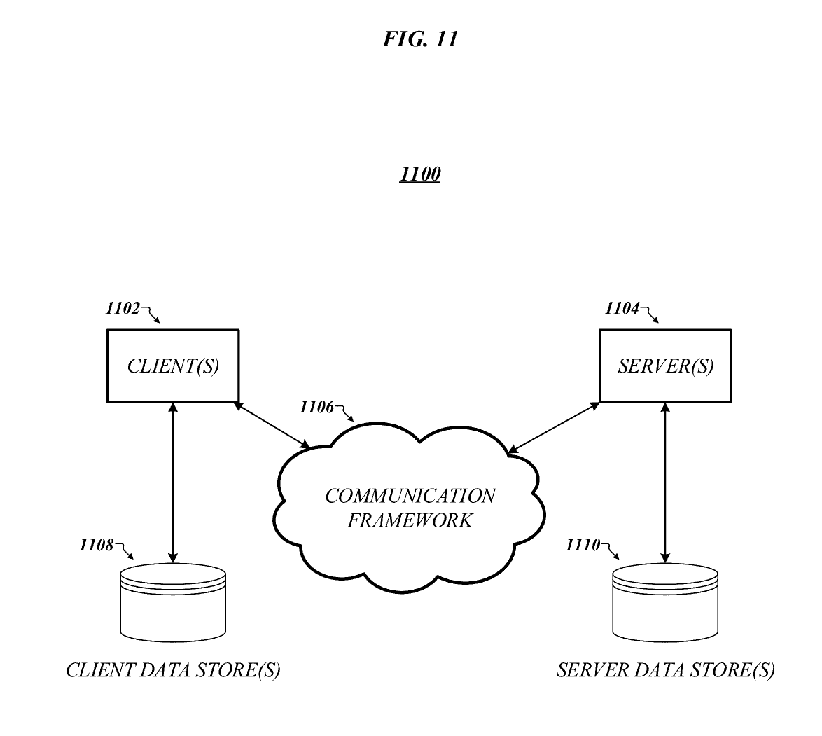

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 and the servers 1104 are operatively connected to one or more respective client data stores 1108 and server data stores 1110 that can be employed to store information local to the respective clients 1102 and servers 1104, such as cookies and/or associated contextual information. In various embodiments, any one of servers 1104 may implement one or more of logic flow 700 of FIG. 7, logic flow 800 of FIG. 8, and storage medium 900 of FIG. 9 in conjunction with storage of data received from any one of clients 1102 on any of server data stores 1110.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

Example 1 is a method, comprising presenting, by processing circuitry of a computing cluster, a first virtual data node to a distributed data storage and processing platform, performing a reliability evaluation procedure to determine whether the first virtual data node constitutes an unreliable virtual data node, and in response to a determination that the first virtual data node constitutes an unreliable virtual data node, performing a virtual data node replacement procedure to replace the first virtual data node with a second virtual data node.

Example 2 is the method of claim 1, the virtual data node replacement procedure to comprise selecting one or more compute resources from among available compute resources of the computing cluster, and instantiating the second virtual data node using the one or more compute resources.

Example 3 is the method of claim 2, the virtual data node replacement procedure to comprise selecting the one or more compute resources from among available compute resources comprised in a spare compute resource pool of the computing cluster.

Example 4 is the method of any of claims 2 to 3, the virtual data node replacement procedure to comprise identifying one or more storage resources allocated to the first virtual data node, reallocating the one or more storage resources to the second virtual data node, and establishing connectivity between the one or more storage resources and the one or more compute resources allocated to the second virtual data node.

Example 5 is the method of any of claims 1 to 4, the virtual data node replacement procedure to comprise identifying, among a plurality of active data node identifiers (IDs) of the distributed data storage and processing platform, a data node ID associated with the first virtual data node, and assigning the identified data node ID to the second virtual data node.

Example 6 is the method of claim 5, the virtual data node replacement procedure to comprise presenting the second virtual data node to the distributed data storage and processing platform using the data node ID assigned to the second virtual data node.

Example 7 is the method of any of claims 1 to 6, the virtual data node replacement procedure to comprise identifying a mount point associated with the first virtual data node, and assigning the identified mount point to the second virtual data node.

Example 8 is the method of claim 7, the virtual data node replacement procedure to comprise presenting the second virtual data node to the distributed data storage and processing platform using the mount point assigned to the second virtual data node.

Example 9 is the method of any of claims 1 to 8, the virtual data node replacement procedure to comprise determining whether any processing tasks are pending for the first virtual data node, and in response to a determination that one or more processing tasks are pending for the first virtual data node, reassigning the one or more processing tasks to the second virtual data node.

Example 10 is the method of any of claims 1 to 9, the reliability evaluation procedure to comprise querying a health monitor for a health score for the first virtual data node, and in response to receipt of the health score for the first virtual data node, determining whether the first virtual data node constitutes an unreliable virtual data node by comparing the health score for the first virtual data node with a health score threshold.

Example 11 is the method of any of claims 1 to 10, the reliability evaluation procedure to comprise determining that the first virtual data node is unreliable in response to a determination that the health monitor is unresponsive.

Example 12 is the method of any of claims 1 to 11, the computing cluster to include a distributed compute resource pool comprising a plurality of compute resources.

Example 13 is the method of claim 12, the computing cluster to include a data storage appliance.

Example 14 is the method of claim 13, the data storage appliance to feature a protected file system.

Example 15 is the method of any of claims 13 to 14, the data storage appliance to comprise a redundant array of independent disks (RAID) 5 storage array, a RAID 6 storage array, or a dynamic disk pool (DDP).

Example 16 is the method of any of claims 13 to 15, the plurality of compute resources to include one or more compute resources communicatively coupled to storage resources of the data storage appliance via an internet small computer system interface (iSCSI) link.

Example 17 is the method of any of claims 13 to 16, the plurality of compute resources to include one or more compute resources communicatively coupled to storage resources of the data storage appliance via a Fibre Channel (FC) link.

Example 18 is the method of any of claims 13 to 17, the plurality of compute resources to include one or more compute resources communicatively coupled to storage resources of the data storage appliance via an InfiniBand (IB) link.

Example 19 is the method of any of claims 1 to 18, the distributed data storage and processing platform to comprise a Hadoop software framework.

Example 20 is the method of claim 19, the Hadoop software framework to comprise a Hadoop 1.0 framework or Hadoop 2.0 framework.

Example 21 is the method of any of claims 1 to 20, comprising configuring the distributed data storage and processing platform to refrain from data replication.

Example 22 is the method of claim 21, comprising configuring the distributed data storage and processing platform to refrain from data replication by setting a data replication factor of the distributed data storage and processing platform to a value of 1.

Example 23 is at least one non-transitory computer-readable storage medium comprising a set of instructions that, in response to being executed on a computing device, cause the computing device to perform a method according to any of claims 1 to 22.

Example 24 is an apparatus, comprising means for performing a method according to any of claims 1 to 22.

Example 25 is the apparatus of claim 24, comprising at least one memory and at least one processor.

Example 26 is a system, comprising an apparatus according to any of claims 24 to 25, and at least one storage device.

Example 27 is a non-transitory machine-readable medium having stored thereon instructions for performing a distributed data storage and processing method, comprising machine-executable code which when executed by at least one machine, causes the machine to present a first virtual data node to a distributed data storage and processing platform of a computing cluster, perform a reliability evaluation procedure to determine whether the first virtual data node constitutes an unreliable virtual data node, and in response to a determination that the first virtual data node constitutes an unreliable virtual data node, perform a virtual data node replacement procedure to replace the first virtual data node with a second virtual data node.

Example 28 is the non-transitory machine-readable medium of claim 27, the virtual data node replacement procedure to comprise selecting one or more compute resources from among available compute resources of the computing cluster, and instantiating the second virtual data node using the one or more compute resources.

Example 29 is the non-transitory machine-readable medium of claim 28, the virtual data node replacement procedure to comprise selecting the one or more compute resources from among available compute resources comprised in a spare compute resource pool of the computing cluster.

Example 30 is the non-transitory machine-readable medium of any of claims 28 to 29, the virtual data node replacement procedure to comprise identifying one or more storage resources allocated to the first virtual data node, reallocating the one or more storage resources to the second virtual data node, and establishing connectivity between the one or more storage resources and the one or more compute resources allocated to the second virtual data node.

Example 31 is the non-transitory machine-readable medium of any of claims 27 to 30, the virtual data node replacement procedure to comprise identifying, among a plurality of active data node identifiers (IDs) of the distributed data storage and processing platform, a data node ID associated with the first virtual data node, and assigning the identified data node ID to the second virtual data node.

Example 32 is the non-transitory machine-readable medium of claim 31, the virtual data node replacement procedure to comprise presenting the second virtual data node to the distributed data storage and processing platform using the data node ID assigned to the second virtual data node.

Example 33 is the non-transitory machine-readable medium of any of claims 27 to 32, the virtual data node replacement procedure to comprise identifying a mount point associated with the first virtual data node, and assigning the identified mount point to the second virtual data node.

Example 34 is the non-transitory machine-readable medium of claim 33, the virtual data node replacement procedure to comprise presenting the second virtual data node to the distributed data storage and processing platform using the mount point assigned to the second virtual data node.

Example 35 is the non-transitory machine-readable medium of any of claims 27 to 34, the virtual data node replacement procedure to comprise determining whether any processing tasks are pending for the first virtual data node, and in response to a determination that one or more processing tasks are pending for the first virtual data node, reassigning the one or more processing tasks to the second virtual data node.

Example 36 is the non-transitory machine-readable medium of any of claims 27 to 35, the reliability evaluation procedure to comprise querying a health monitor for a health score for the first virtual data node, and in response to receipt of the health score for the first virtual data node, determining whether the first virtual data node constitutes an unreliable virtual data node by comparing the health score for the first virtual data node with a health score threshold.

Example 37 is the non-transitory machine-readable medium of any of claims 27 to 36, the reliability evaluation procedure to comprise determining that the first virtual data node is unreliable in response to a determination that the health monitor is unresponsive.

Example 38 is the non-transitory machine-readable medium of any of claims 27 to 37, the computing cluster to include a distributed compute resource pool comprising a plurality of compute resources.

Example 39 is the non-transitory machine-readable medium of claim 38, the computing cluster to include a data storage appliance.

Example 40 is the non-transitory machine-readable medium of claim 39, the data storage appliance to feature a protected file system.

Example 41 is the non-transitory machine-readable medium of any of claims 39 to 40, the data storage appliance to comprise a redundant array of independent disks (RAID) 5 storage array, a RAID 6 storage array, or a dynamic disk pool (DDP).

Example 42 is the non-transitory machine-readable medium of any of claims 39 to 41, the plurality of compute resources to include one or more compute resources communicatively coupled to storage resources of the data storage appliance via an internet small computer system interface (iSCSI) link.

Example 43 is the non-transitory machine-readable medium of any of claims 39 to 42, the plurality of compute resources to include one or more compute resources communicatively coupled to storage resources of the data storage appliance via a Fibre Channel (FC) link.

Example 44 is the non-transitory machine-readable medium of any of claims 39 to 43, the plurality of compute resources to include one or more compute resources communicatively coupled to storage resources of the data storage appliance via an InfiniBand (IB) link.

Example 45 is the non-transitory machine-readable medium of any of claims 27 to 44, the distributed data storage and processing platform to comprise a Hadoop software framework.

Example 46 is the non-transitory machine-readable medium of claim 45, the Hadoop software framework to comprise a Hadoop 1.0 framework or Hadoop 2.0 framework.

Example 47 is the non-transitory machine-readable medium of any of claims 27 to 46, comprising machine-executable code which when executed by the at least one machine, causes the machine to configure the distributed data storage and processing platform to refrain from data replication.

Example 48 is the non-transitory machine-readable medium of claim 47, comprising machine-executable code which when executed by the at least one machine, causes the machine to configure the distributed data storage and processing platform to refrain from data replication by setting a data replication factor of the distributed data storage and processing platform to a value of 1.

Example 49 is a computing device, comprising a memory containing a machine-readable medium comprising machine-executable code, having stored thereon instructions for performing a distributed data storage and processing method, and a processor coupled to the memory, the processor configured to execute the machine-executable code to cause the processor to present a first virtual data node to a distributed data storage and processing platform of a computing cluster, perform a reliability evaluation procedure to determine whether the first virtual data node constitutes an unreliable virtual data node, and in response to a determination that the first virtual data node constitutes an unreliable virtual data node, perform a virtual data node replacement procedure to replace the first virtual data node with a second virtual data node.

Example 50 is the computing device of claim 49, the virtual data node replacement procedure to comprise selecting one or more compute resources from among available compute resources of the computing cluster, and instantiating the second virtual data node using the one or more compute resources.

Example 51 is the computing device of claim 50, the virtual data node replacement procedure to comprise selecting the one or more compute resources from among available compute resources comprised in a spare compute resource pool of the computing cluster.

Example 52 is the computing device of any of claims 50 to 51, the virtual data node replacement procedure to comprise identifying one or more storage resources allocated to the first virtual data node, reallocating the one or more storage resources to the second virtual data node, and establishing connectivity between the one or more storage resources and the one or more compute resources allocated to the second virtual data node.

Example 53 is the computing device of any of claims 49 to 52, the virtual data node replacement procedure to comprise identifying, among a plurality of active data node identifiers (IDs) of the distributed data storage and processing platform, a data node ID associated with the first virtual data node, and assigning the identified data node ID to the second virtual data node.

Example 54 is the computing device of claim 53, the virtual data node replacement procedure to comprise presenting the second virtual data node to the distributed data storage and processing platform using the data node ID assigned to the second virtual data node.

Example 55 is the computing device of any of claims 49 to 54, the virtual data node replacement procedure to comprise identifying a mount point associated with the first virtual data node, and assigning the identified mount point to the second virtual data node.

Example 56 is the computing device of claim 55, the virtual data node replacement procedure to comprise presenting the second virtual data node to the distributed data storage and processing platform using the mount point assigned to the second virtual data node.

Example 57 is the computing device of any of claims 49 to 56, the virtual data node replacement procedure to comprise determining whether any processing tasks are pending for the first virtual data node, and in response to a determination that one or more processing tasks are pending for the first virtual data node, reassigning the one or more processing tasks to the second virtual data node.

Example 58 is the computing device of any of claims 49 to 57, the reliability evaluation procedure to comprise querying a health monitor for a health score for the first virtual data node, and in response to receipt of the health score for the first virtual data node, determining whether the first virtual data node constitutes an unreliable virtual data node by comparing the health score for the first virtual data node with a health score threshold.

Example 59 is the computing device of any of claims 49 to 58, the reliability evaluation procedure to comprise determining that the first virtual data node is unreliable in response to a determination that the health monitor is unresponsive.

Example 60 is the computing device of any of claims 49 to 59, the computing cluster to include a distributed compute resource pool comprising a plurality of compute resources.

Example 61 is the computing device of claim 60, the computing cluster to include a data storage appliance.

Example 62 is the computing device of claim 61, the data storage appliance to feature a protected file system.

Example 63 is the computing device of any of claims 61 to 62, the data storage appliance to comprise a redundant array of independent disks (RAID) 5 storage array, a RAID 6 storage array, or a dynamic disk pool (DDP).

Example 64 is the computing device of any of claims 61 to 63, the plurality of compute resources to include one or more compute resources communicatively coupled to storage resources of the data storage appliance via an internet small computer system interface (iSCSI) link.

Example 65 is the computing device of any of claims 61 to 64, the plurality of compute resources to include one or more compute resources communicatively coupled to storage resources of the data storage appliance via a Fibre Channel (FC) link.

Example 66 is the computing device of any of claims 61 to 65, the plurality of compute resources to include one or more compute resources communicatively coupled to storage resources of the data storage appliance via an InfiniB and (TB) link.

Example 67 is the computing device of any of claims 49 to 66, the distributed data storage and processing platform to comprise a Hadoop software framework.

Example 68 is the computing device of claim 67, the Hadoop software framework to comprise a Hadoop 1.0 framework or Hadoop 2.0 framework.

Example 69 is the computing device of any of claims 49 to 68, the processor configured to execute the machine-executable code to cause the processor to configure the distributed data storage and processing platform to refrain from data replication.

Example 70 is the computing device of claim 69, the processor configured to execute the machine-executable code to cause the processor to configure the distributed data storage and processing platform to refrain from data replication by setting a data replication factor of the distributed data storage and processing platform to a value of 1.

Example 71 is a system, comprising a computing device according to any of claims 49 to 70, and at least one storage device.

Example 72 is an apparatus, comprising means for presenting a first virtual data node to a distributed data storage and processing platform of a computing cluster, means for performing a reliability evaluation procedure to determine whether the first virtual data node constitutes an unreliable virtual data node, and means for performing a virtual data node replacement procedure to replace the first virtual data node with a second virtual data node in response to a determination that the first virtual data node constitutes an unreliable virtual data node.

Example 73 is the apparatus of claim 72, the virtual data node replacement procedure to comprise selecting one or more compute resources from among available compute resources of the computing cluster, and instantiating the second virtual data node using the one or more compute resources.

Example 74 is the apparatus of claim 73, the virtual data node replacement procedure to comprise selecting the one or more compute resources from among available compute resources comprised in a spare compute resource pool of the computing cluster.

Example 75 is the apparatus of any of claims 73 to 74, the virtual data node replacement procedure to comprise identifying one or more storage resources allocated to the first virtual data node, reallocating the one or more storage resources to the second virtual data node, and establishing connectivity between the one or more storage resources and the one or more compute resources allocated to the second virtual data node.

Example 76 is the apparatus of any of claims 72 to 75, the virtual data node replacement procedure to comprise identifying, among a plurality of active data node identifiers (IDs) of the distributed data storage and processing platform, a data node ID associated with the first virtual data node, and assigning the identified data node ID to the second virtual data node.

Example 77 is the apparatus of claim 76, the virtual data node replacement procedure to comprise presenting the second virtual data node to the distributed data storage and processing platform using the data node ID assigned to the second virtual data node.

Example 78 is the apparatus of any of claims 72 to 77, the virtual data node replacement procedure to comprise identifying a mount point associated with the first virtual data node, and assigning the identified mount point to the second virtual data node.

Example 79 is the apparatus of claim 78, the virtual data node replacement procedure to comprise presenting the second virtual data node to the distributed data storage and processing platform using the mount point assigned to the second virtual data node.

Example 80 is the apparatus of any of claims 72 to 79, the virtual data node replacement procedure to comprise determining whether any processing tasks are pending for the first virtual data node, and in response to a determination that one or more processing tasks are pending for the first virtual data node, reassigning the one or more processing tasks to the second virtual data node.

Example 81 is the apparatus of any of claims 72 to 80, the reliability evaluation procedure to comprise querying a health monitor for a health score for the first virtual data node, and in response to receipt of the health score for the first virtual data node, determining whether the first virtual data node constitutes an unreliable virtual data node by comparing the health score for the first virtual data node with a health score threshold.

Example 82 is the apparatus of any of claims 72 to 81, the reliability evaluation procedure to comprise determining that the first virtual data node is unreliable in response to a determination that the health monitor is unresponsive.

Example 83 is the apparatus of any of claims 72 to 82, the computing cluster to include a distributed compute resource pool comprising a plurality of compute resources.

Example 84 is the apparatus of claim 83, the computing cluster to include a data storage appliance.

Example 85 is the apparatus of claim 84, the data storage appliance to feature a protected file system.

Example 86 is the apparatus of any of claims 84 to 85, the data storage appliance to comprise a redundant array of independent disks (RAID) 5 storage array, a RAID 6 storage array, or a dynamic disk pool (DDP).

Example 87 is the apparatus of any of claims 84 to 86, the plurality of compute resources to include one or more compute resources communicatively coupled to storage resources of the data storage appliance via an internet small computer system interface (iSCSI) link.

Example 88 is the apparatus of any of claims 84 to 87, the plurality of compute resources to include one or more compute resources communicatively coupled to storage resources of the data storage appliance via a Fibre Channel (FC) link.

Example 89 is the apparatus of any of claims 84 to 88, the plurality of compute resources to include one or more compute resources communicatively coupled to storage resources of the data storage appliance via an InfiniBand (IB) link.

Example 90 is the apparatus of any of claims 72 to 89, the distributed data storage and processing platform to comprise a Hadoop software framework.

Example 91 is the apparatus of claim 90, the Hadoop software framework to comprise a Hadoop 1.0 framework or Hadoop 2.0 framework.

Example 92 is the apparatus of any of claims 72 to 91, comprising means for configuring the distributed data storage and processing platform to refrain from data replication.

Example 93 is the apparatus of claim 92, comprising means for configuring the distributed data storage and processing platform to refrain from data replication by setting a data replication factor of the distributed data storage and processing platform to a value of 1.

Example 94 is the apparatus of any of claims 72 to 93, comprising at least one memory and at least one processor.

Example 95 is a system, comprising the apparatus of any of claims 72 to 94, and at least one storage device.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, novel subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
presenting, by processing circuitry of a storage server communicatively coupled with a computing cluster, a first virtual data node to a distributed data storage and processing platform;
performing a reliability evaluation procedure to determine whether the first virtual data node constitutes an unreliable virtual data node; and
in response to a determination that the first virtual data node constitutes an unreliable virtual data node, performing a virtual data node replacement procedure to replace the first virtual data node with a second virtual data node.

2. The method of claim 1, the virtual data node replacement procedure to comprise:
identifying, among a plurality of active data node identifiers (IDs) of the distributed data storage and processing platform, a data node ID associated with the first virtual data node; and
assigning the identified data node ID to the second virtual data node.

3. The method of claim 1, the reliability evaluation procedure to comprise:
querying a health monitor for a health score for the first virtual data node; and
in response to receipt of the health score for the first virtual data node, determining whether the first virtual data node constitutes an unreliable virtual data node by comparing the health score for the first virtual data node with a health score threshold.

4. The method of claim 1, the reliability evaluation procedure to comprise determining that the first virtual data node is unreliable in response to a determination that the health monitor is unresponsive.

5. The method of claim 1, the computing cluster to include a data storage appliance comprising a redundant array of independent disks (RAID) 5 storage array, a RAID 6 storage array, or a dynamic disk pool (DDP).

6. The method of claim 5, the computing cluster to include one or more compute resources communicatively coupled to storage resources of the data storage appliance via at least one of:
an internet small computer system interface (iSCSI) link;
a Fibre Channel (FC) link; and
an InfiniB and (IB) link.

7. The method of claim 1, comprising configuring the distributed data storage and processing platform to refrain from data replication.

8. A non-transitory machine-readable medium having stored thereon instructions for performing a distributed data storage and processing method, comprising machine-executable code which when executed by at least one machine, causes the machine to:
present a first virtual data node to a distributed data storage and processing platform of a computing cluster;
perform a reliability evaluation procedure to determine whether the first virtual data node constitutes an unreliable virtual data node; and
in response to a determination that the first virtual data node constitutes an unreliable virtual data node, perform a virtual data node replacement procedure to replace the first virtual data node with a second virtual data node.

9. The non-transitory machine-readable medium of claim 8, the virtual data node replacement procedure to comprise:
identifying, among a plurality of active data node identifiers (IDs) of the distributed data storage and processing platform, a data node ID associated with the first virtual data node; and
assigning the identified data node ID to the second virtual data node.

10. The non-transitory machine-readable medium of claim 8, the reliability evaluation procedure to comprise:
querying a health monitor for a health score for the first virtual data node;
in response to receipt of the health score for the first virtual data node, determining whether the first virtual data node constitutes an unreliable virtual data node by comparing the health score for the first virtual data node with a health score threshold; and
in response to a determination that the health monitor is unresponsive, determining that the first virtual data node is unreliable.

11. The non-transitory machine-readable medium of claim 8, the computing cluster to include a data storage appliance comprising a redundant array of independent disks (RAID) 5 storage array, a RAID 6 storage array, or a dynamic disk pool (DDP).

12. The non-transitory machine-readable medium of claim 11, the computing cluster to include one or more compute resources communicatively coupled to storage resources of the data storage appliance via at least one of:
an internet small computer system interface (iSCSI) link;
a Fibre Channel (FC) link; and
an InfiniB and (IB) link.

13. The non-transitory machine-readable medium of claim 8, the distributed data storage and processing platform to comprise a Hadoop software framework.

14. A computing device, comprising:
a memory containing a machine-readable medium comprising machine-executable code, having stored thereon instructions for performing a distributed data storage and processing method; and
a processor coupled to the memory, the processor configured to execute the machine-executable code to cause the processor to:
present a first virtual data node to a distributed data storage and processing platform of a computing cluster;
perform a reliability evaluation procedure to determine whether the first virtual data node constitutes an unreliable virtual data node; and
in response to a determination that the first virtual data node constitutes an unreliable virtual data node, perform a virtual data node replacement procedure to replace the first virtual data node with a second virtual data node.

15. The computing device of claim 14, the virtual data node replacement procedure to comprise:
identifying, among a plurality of active data node identifiers (IDs) of the distributed data storage and processing platform, a data node ID associated with the first virtual data node; and
assigning the identified data node ID to the second virtual data node.

16. The computing device of claim 14, the reliability evaluation procedure to comprise:
querying a health monitor for a health score for the first virtual data node;
in response to receipt of the health score for the first virtual data node, determining whether the first virtual data node constitutes an unreliable virtual data node by comparing the health score for the first virtual data node with a health score threshold; and
in response to a determination that the health monitor is unresponsive, determining that the first virtual data node is unreliable.

17. The computing device of claim 14, the computing cluster to include a data storage appliance comprising a redundant array of independent disks (RAID) 5 storage array, a RAID 6 storage array, or a dynamic disk pool (DDP).

18. The computing device of claim 14, the distributed data storage and processing platform to comprise a Hadoop software framework.

19. The computing device of claim 14, the processor configured to execute the machine-executable code to cause the processor to configure the distributed data storage and processing platform to refrain from data replication.

20. A system, comprising:
the computing device of claim 14; and
at least one storage device.
